(19) United States
(12) Patent Application Publication
(10) Pub. No.: US 2012/0081281 A1
(43) Pub. Date: Apr. 5, 2012

(54) INFORMATION DISPLAY APPARATUS FOR MAP DISPLAY

(75) Inventor: Kazumasa MORICHIKA, Tokyo (JP)

(73) Assignee: Casio Compter Co., Ltd., Tokyo (JP)

(21) Appl. No.: 13/252,370

(22) Filed: Oct. 4, 2011

(30) Foreign Application Priority Data
Oct. 5, 2010 (JP) 2010-225505

(51) Int. Cl. G09G 5/00

(52) U.S. Cl. 345/156

(57) ABSTRACT

An information display apparatus, including a nonvolatile database memory 14 that stores map data, a display unit 16, a user state detection unit 31 that detects a kind of user movement state indicative of a current user movement state from among a plurality of kinds of user movement states, a display setting unit 32 that sets a display form of the map data to be displayed by the display unit based on the user movement state detected by the user state detection unit, and a display control unit 33 that controls a display of the map data by the display unit in the display form set by the display setting unit.

This application is based on and claims the benefit of priority from Japanese Patent Application No. 2010-225505, filed on 5 Oct. 2010, the content of which is incorporated herein by reference.

### BACKGROUND OF THE INVENTION

1. Field of the Invention

The present invention relates to an information display apparatus, method, and storage medium, and more particularly to a technique that displays a map in an appropriate display form in accordance with a user movement state.

2. Description of the Related Art

Recently, there are navigation devices that can be used not only in a state of being mounted on a vehicle (hereinafter, referred to as “on-vehicle state”) but also in a state of being detached from a vehicle (hereinafter, referred to as “off-vehicle state”).

Here, the moving speed of a navigation device, i.e., the moving speed of a user who is checking a map on the navigation device greatly changes depending upon whether the navigation device is in the on-vehicle state or the off-vehicle state.

Therefore, if the map is displayed always at the same scale regardless of whether the device is in the on-vehicle state or in the off-vehicle state, it becomes difficult for the user to acquire accurate information from the map.

A technique of changing the map scale to the most detailed map scale when the navigation device transits from the on-vehicle state to the off-vehicle state is disclosed in Japanese Patent Application Publication No. 2008-286577.

### SUMMARY OF THE INVENTION

It is an object of the present invention to display a map in an appropriate display form in accordance with a user movement state.

In order to attain the aforementioned object of the present invention, in accordance with a first aspect of the present invention, there is provided an information display apparatus, comprising: a storage unit that stores map data; a display unit; a user state detection unit that detects a user movement state indicative of a current user movement state; a display setting unit that sets a display form of the map data to be displayed by the display unit based on the user movement state detected by the user state detection unit; and a display control unit that controls a display of the map data by the display unit in the display form set by the display setting unit.

In order to attain the aforementioned object of the present invention, in accordance with a second aspect of the present invention, there is provided an information display method of an information display apparatus that displays map data stored in a storage unit on a display unit, the method comprising: a user state detection step of detecting a user movement state indicative of a current user movement state; a display setting step of setting a display form of the map data to be displayed by the display unit based on the user movement state detected in the user state detection step; and a display control step of controlling a display of the map data by the display unit in the display form set in the display setting step.

In accordance with a third aspect of the present invention, there is provided storage medium having stored therein a program causing a computer that controls an information display apparatus that displays map data stored in a storage unit on a display unit to implement: a user state detection function that detects a kind of user movement state indicative of a current user movement state; a display setting function that sets a display form of the map data to be displayed by the display unit based on the user movement state detected by the user state detection function; and a display control function that controls a display of the map data by the display unit in the display form set by the display setting function.

### BRIEF DESCRIPTION OF THE DRAWINGS

FIG. 1 is a block diagram showing a hardware configuration of the information display apparatus according to one embodiment of the present invention;

FIG. 2 is a functional block diagram showing a functional configuration of the information display apparatus;

FIG. 3 is a structural example of a table (storage area) to register (store) movement states of a user and detection conditions thereof from a nonvolatile database memory;

FIG. 4 is a flowchart showing flow of the map display processing;

FIG. 5 is a diagram showing one example of the map displayed on the display unit;

FIG. 6 is a diagram showing one example of the map displayed on the display unit; and

FIG. 7 is a diagram showing one example of the map displayed on the display unit.

### DETAILED DESCRIPTION OF THE INVENTION

An embodiment of the present invention will be described hereinafter with reference to the drawings.

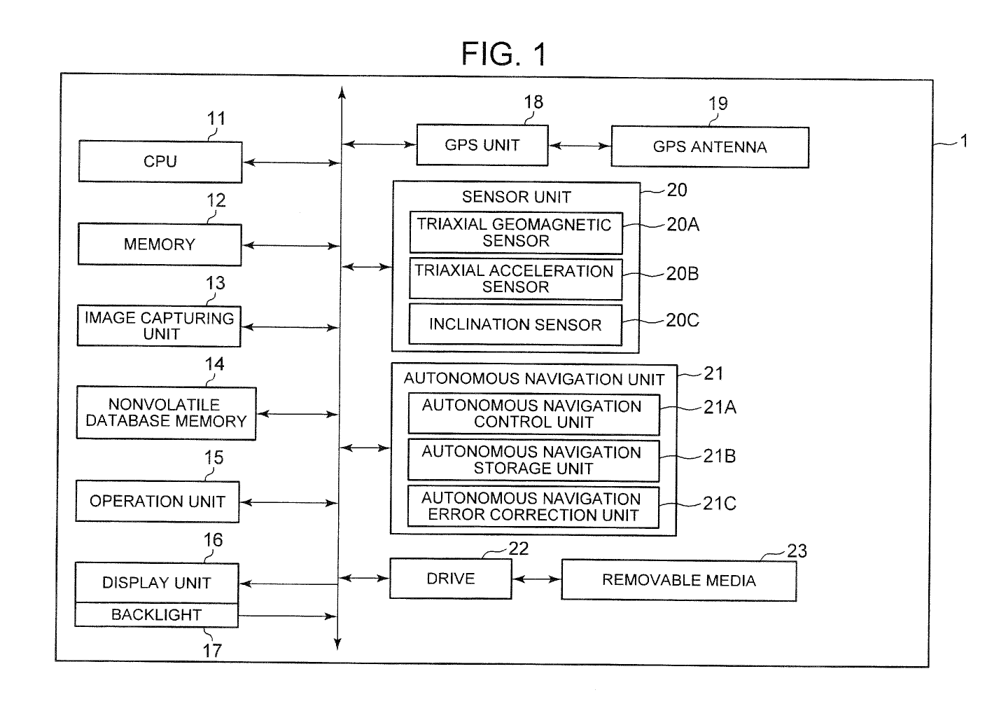

FIG. 1 is a block diagram showing a hardware configuration of the information display apparatus according to one embodiment of the present invention.

The information display apparatus can be configured by a digital camera 1 equipped with a GPS (Global Positioning System) function, for example.

The digital camera 1 is provided with a CPU (Central Processing Unit) 11, a memory 12, an image capturing unit 13, a nonvolatile database memory 14, an operation unit 15, a display unit 16, a backlight 17, a GPS unit 18, a GPS antenna 19, a sensor unit 20, an autonomous navigation unit 21, and a drive 22.

The CPU 11 executes various processes including map display processing, which will be described later, according to programs that are stored in the memory 12.

The memory 12 is constituted by a ROM (Read Only Memory), a RAM (Random Access Memory), a DRAM (Dynamic Random Access Memory), and the like, for example.

In the memory 12, the ROM stores programs and the like necessary for the CPU 11 to execute various processes, and the RAM also stores data and the like necessary for the CPU 11 to execute the various processes as appropriate.

Furthermore, the DRAM included in the memory 12 temporarily stores audio data, image data outputted from the image capturing unit 13, which will be described later, and the like. Also, the DRAM stores various kinds of data necessary for audio processing and various kinds of image processing.

Furthermore, the DRAM includes a video memory area to store and read data of an image for displaying the image.

The image capturing unit 13 is provided with an optical lens unit and an image sensor.

The optical lens unit is configured by a light condensing lens such as a focus lens, a zoom lens, and the like, for example, to photograph a subject included within an angle of view for image capturing.

The focus lens is a lens for forming an image of a subject on the light receiving surface of the image sensor.

The zoom lens is a lens for freely changing a focal point within a predetermined range.

The optical lens unit includes peripheral circuits to adjust parameters such as focus, exposure, white balance, and the like.

The image sensor is configured by an optoelectronic conversion device, an AFE (Analog Front End), and the like, for example.

The optoelectronic conversion device is configured by a CMOS (Complementary Metal Oxide Semiconductor) type optoelectronic conversion device, or the like, for example.

An image of a subject is incident through the optical lens unit on the optoelectronic conversion device. The optoelectronic conversion device optoelectronically converts (i.e. captures) an image of a subject as an image signal at a predetermined interval, stores the image signal thus converted, and sequentially supplies the stored image signal to the AFE as an analog signal.

The AFE executes various kinds of signal processing such as A/D (Analog/Digital) conversion on the analog image signal.

As a result of the various kinds of signal processing, a digital signal is generated.

Then, the digital signal is outputted as an output signal from the image sensor.

Hereinafter, the digital signal of the image signal is referred to as “image data”.

Thus, the image data is finally outputted from the image capturing unit 13 and provided to the memory 12.

The nonvolatile database memory 14 stores various kinds of data accumulated as a database.

For example, in the present embodiment, the nonvolatile database memory 14 stores a plurality of items of map data including map information and location information in association with data of objects including location information.

The operation unit 15 is configured by various buttons and keys such as a shutter key, a power button, a zoom key, a mode switching key, and the like.

When a user presses and operates one of the various buttons and keys, an operation signal corresponding to the button or the key thus pressed and operated is generated and supplied to the CPU 11.

The display unit 16 is configured by an LCD (Liquid Crystal Device) display, for example, and displays various images.

For example, in the present embodiment, the display unit 16 displays a map based on the current location of the digital camera 1.

The backlight 17 illuminates the LCD display constituting the display unit 16 from the back thereof. That is, as the brightness state, or the like, of the backlight 17 changes, the brightness (luminance) or the like of an image displayed on the display unit 16 also changes.

The GPS unit 18 receives GPS signals from a plurality of GPS satellites via the GPS antenna 19. Based on the received GPS signals, the GPS unit 18 calculates latitude, longitude, altitude, and the like as location information indicative of the current location of the digital camera 1.

The sensor unit 20 is provided with a triaxial geomagnetic sensor 20A, a triaxial acceleration sensor 20B, and an inclination sensor 20C.

The triaxial geomagnetic sensor 20A includes an MI (Magneto-Impedance) element whose impedance changes according to the ambient magnetic field fluctuation, for example. The triaxial geomagnetic sensor 20A detects the triaxial (X, Y, Z) direction components of the geomagnetic field by way of the MI element, and outputs data indicative of the detection result. Hereinafter, the data indicative of the detection result of the triaxial geomagnetic sensor 20A is referred to as “triaxial geomagnetic data”.

The triaxial acceleration sensor 20B includes a piezoresistive type or electrostatic capacity type detection mechanism. The triaxial acceleration sensor 20B detects the triaxial (X, Y, Z) direction components of the acceleration of a user holding the digital camera 1 by way of the detection mechanism, and outputs data indicative of the detection result. Hereinafter, the data indicative of the detection result of the triaxial acceleration sensor 20B is referred to as “triaxial acceleration data”.

From among the triaxial direction components of the triaxial acceleration data, the X axis direction component corresponds to a direction component of the gravitational acceleration (vertical direction component) of the digital camera 1.

The Y-axial direction component corresponds to a direction component in a direction perpendicular to an advancing direction of a user (lateral component) in a horizontal plane perpendicular to the gravity acceleration direction.

The Z-axial direction component corresponds to the advancing direction of the user (advancing direction component) in the horizontal plane perpendicular to the gravity acceleration direction.

Even in a state kept at any arbitrary inclination, the triaxial acceleration sensor 20B can output the triaxial acceleration data in accordance with the inclination.

Therefore, it is assumed that the CPU 11 corrects data outputted from sensors having movable mechanisms, more particularly, from the inclination sensor 20C having a gyro sensor, in accordance with the data outputted from the triaxial acceleration sensor 20B, which has been corrected in accordance with the inclination.

With this, the CPU 11 can accurately acquire various kinds of data and execute positioning calculation even in a case in which the digital camera 1 is subject to an external force such as a centrifugal force, for example, when an image of a subject is captured while traveling on a tram, a car, or the like.

The inclination sensor 20C includes an angular velocity sensor such as a piezoelectric oscillation gyro that outputs a voltage value in accordance with the applied angular velocity, or the like.

The detection result of the inclination sensor 20C does not immediately indicate the inclination of the digital camera 1, but the amount of change in inclination of the digital camera 1 is calculated by the CPU 11 based on the detection result (a voltage value indicating angular velocity) of the inclination sensor 20C.

More particularly, the CPU 11 integrates voltage values sequentially outputted from the inclination sensor 20C, and generates inclination variation data indicative of the amount of change in inclination.

Since the CPU 11 corrects the detection result of the inclination sensor 20C based on the detection result of the triaxial acceleration sensor 20B, orientation can be measured even in any state subject to an external force such as centrifugal force.

The autonomous navigation unit 21 outputs auxiliary information (hereinafter, referred to as “positioning auxiliary information”) necessary for the CPU 11 to calculate the location information by way of compensation when the location information outputted from the GPS unit 18 is lost, or when the GPS unit 18 is driven to intermittently output the location information.

In order to output the positioning auxiliary information, the autonomous navigation unit 21 includes an autonomous navigation control unit 21A, an autonomous navigation storage unit 21B, and an autonomous navigation error correction unit 21C.

The autonomous navigation control unit 21A calculates the orientation of the advancing direction of the user holding the digital camera 1 based on the triaxial geomagnetic data outputted from the triaxial geomagnetic sensor 20A and the triaxial acceleration sensor 20B.

Furthermore, the autonomous navigation control unit 21A calculates the moving distance of the user holding the digital camera 1 by integrating the advancing direction component of the triaxial acceleration data sequentially outputted from the triaxial acceleration sensor 20B.

Here, the moving distance is intended to mean a distance from a predetermined starting location to the current location of the user holding the digital camera 1.

The predetermined starting location is intended to mean the location when the autonomous navigation control unit 21A has started the integration.

This means that the predetermined starting location means the location of the user holding the digital camera 1 at the point of time when the integration value is set to 0 in the initial setting or when the integration value is reset to 0 after that.

The autonomous navigation control unit 21A supplies information indicative of the moving orientation and the moving distance thus calculated to the CPU 11 as the positioning auxiliary information.

The CPU 11 calculates location information such as latitude, longitude, altitude, and the like based on the positioning auxiliary information.

The autonomous navigation control unit 21A corrects the positioning auxiliary information based on the correction information supplied from the autonomous navigation error correction unit 21C, which will be described later.

In order to generate the correction information, it is necessary to keep a history of the positioning auxiliary information corresponding to the location information from the GPS unit 18.

Therefore, the autonomous navigation control unit 21A continually outputs the positioning auxiliary information regardless of whether or not the GPS unit 18 outputs the location information.

The autonomous navigation storage unit 21B stores as appropriate the calculation result of the autonomous navigation unit 21, information necessary for the calculation, and the like.

For example, the autonomous navigation storage unit 21B stores positioning auxiliary information, i.e., the moving orientation and the moving distance of the user holding the digital camera 1, outputted from the autonomous navigation control unit 21A.

The autonomous navigation error correction unit 21C generates information (hereinafter, referred to as “correction information”) to correct the error, derived from the detection result of the sensor unit 20, of the positioning auxiliary information (the moving orientation and the moving distance of the user holding the digital camera 1).

The autonomous navigation error correction unit 21C supplies the correction information thus generated to the autonomous navigation control unit 21A.

Here, the autonomous navigation control unit 21A corrects the positioning auxiliary information by way of the correction information.

With this, it becomes possible to acquire positioning auxiliary information in which the error derived from the detection result of the sensor unit 20 has been reduced.

For example, the detection result of the sensor unit 20 is sensitive to temperature change.

Therefore, the positioning auxiliary information may have an error derived from the detection result of the sensor unit 20 subject to the temperature change.

The autonomous navigation error correction unit 21C continually calculates respective differences between the moving orientations and the moving distance calculated as the positioning auxiliary information by the autonomous navigation control unit 21A and the moving orientation and the moving distance specified by way of the location information outputted from the GPS unit 18.

More specifically, the difference between the moving orientations and the ratio of the moving distances is calculated as correction information.

The autonomous navigation error correction unit 21C stores in the autonomous navigation storage unit 21B as correction information the data (hereinafter, referred to as “difference data”) indicative of the calculation result, in association with temperature and amount of temperature change at the time when the difference data is acquired.

Here, the autonomous navigation control unit 21A acquires as correction information, when calculating the moving orientation and the moving distance, the difference data corresponding to the temperature at this point in time from the autonomous navigation storage unit 21B.

By way of the correction information, the autonomous navigation control unit 21A corrects the positioning auxiliary information.

With this, it becomes possible to acquire positioning auxiliary information in which the error derived from the detection result of the sensor unit 20 has been reduced.

To the drive 22, removable media 23 such as a magnetic disk, an optical disk, a magneto-optical disk, or a semiconductor memory is mounted as appropriate.

Programs read by the drive 22 from the removable media 23 are installed in the memory 12, the nonvolatile database memory 14, or the like as needed.

The removable media 23 may store data of a plurality of maps in association with data of objects, in place of the nonvolatile database memory 14.

The removable media 23 can similarly store various kinds of data such as image data and the like stored in the memory 12 and the like.

The digital camera 1 having such a configuration can carry out the following series of processes.

The digital camera 1 acquires the vibration frequency of the component in each direction of the triaxial acceleration data and the amplitude thereof outputted from the triaxial acceleration sensor 20B.

The digital camera 1 detects the user movement state based on the vibration frequency and the amplitude thereof.

There are plural kinds of user movement states that can be detected.

From among the plural kinds, a kind of user movement state that is suitable to the current user movement state is detected.

The digital camera 1 sets a display form of the map to be displayed on the display unit 16 based on the detected kind of movement state of the user.

More particularly, in the present embodiment, the digital camera 1 sets the scale of the map to be displayed on the display unit 16 based on the user movement state.

The digital camera 1 executes control so that the display unit 16 displays the map in the display form thus set.

Hereinafter, such a series of processing is referred to as “map display processing”.

By carrying out the map display processing, a map is displayed on the display unit 16 in a preferable display form, more particularly, in a preferable scale for the user movement state in the present embodiment.

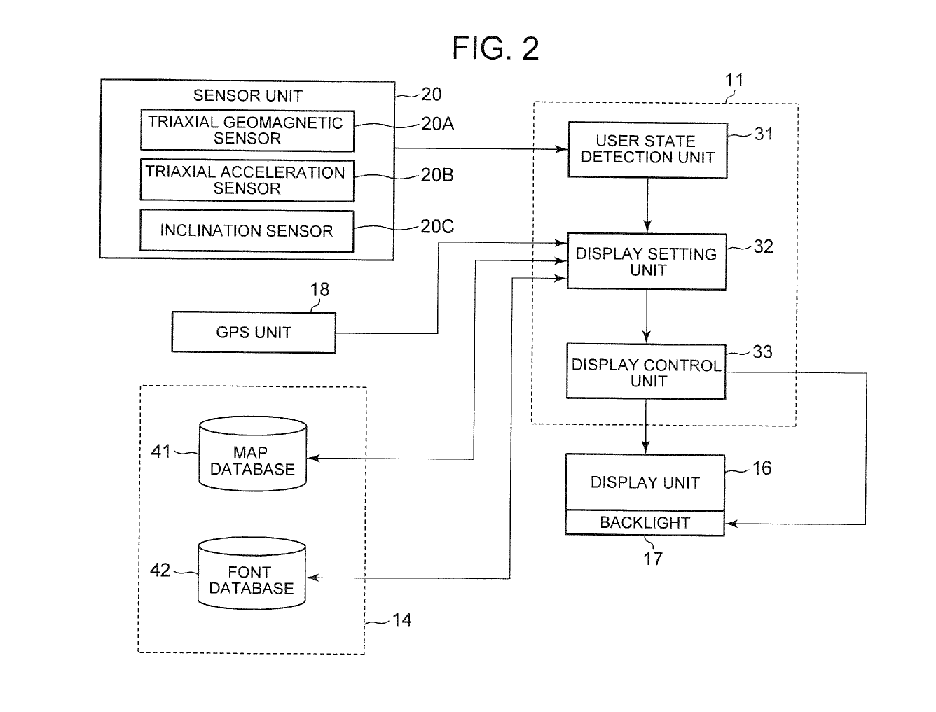

FIG. 2 is a functional block diagram showing a functional configuration of the digital camera 1 to carry out the map display processing.

In FIG. 2, from among the constituent elements of the configuration of the digital camera 1 shown in FIG. 1, there are illustrated only the CPU 11, the nonvolatile database memory 14, the display unit 16, the backlight 17, the GPS unit 18, and the sensor unit 20.

The CPU 11 includes a user state detection unit 31, a display setting unit 32, and a display control unit 33.

The nonvolatile database memory 14 includes a map database 41 (hereinafter, referred to as “map DB 41”) and a font database 42 (hereinafter, referred to as “font DB 42”).

The user state detection unit 31 acquires acceleration data of each direction component outputted from the triaxial acceleration sensor 20B of the sensor unit 20.

The user state detection unit 31 detects the user movement state using, for example, the vibration frequency and the amplitude thereof.

Hereinafter, such a series of processing up to the processing by which the user state detection unit 31 detects the user movement state is referred to as “state detection processing”.

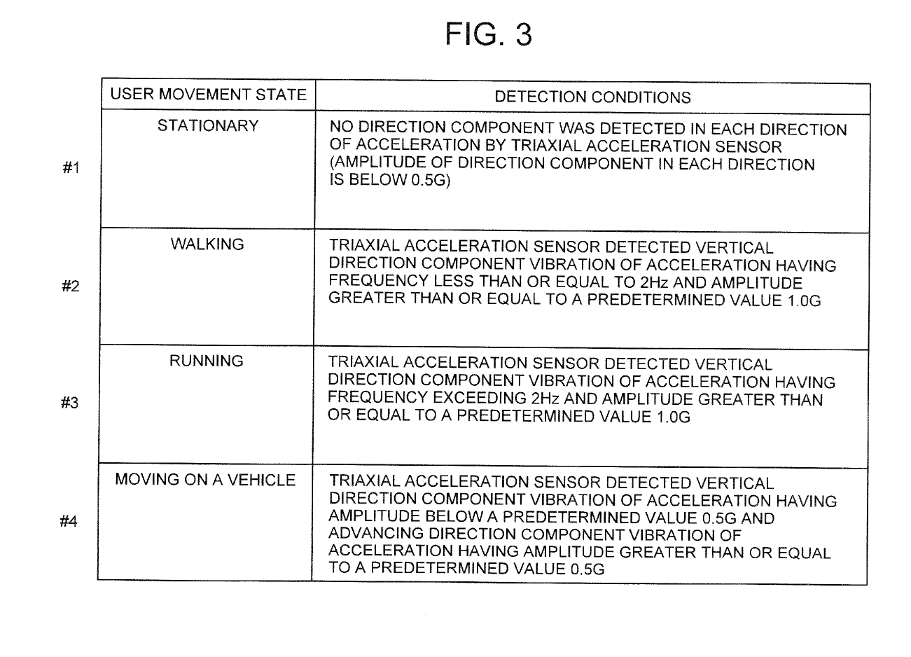

For example, processing that detects the user movement state based on a table shown in FIG. 3 is employed as the state detection processing in the present embodiment.

FIG. 3 is a structural example of a table (storage area) to register (store) user movement states and detection conditions thereof from among storage areas of the nonvolatile database memory 14.

In the present embodiment, as shown in FIG. 3, there are 4 kinds of movement state, i.e., “Stationary”, “Walking”, “Running”, and “Moving on a vehicle” are detectable by the state detection processing.

In the example of FIG. 3, since the table has a matrix structure, hereinafter, a set of items in a horizontal line shown in FIG. 3 is referred to as a “row”, and a set of items in a vertical line shown in FIG. 3 is referred to as a “column”.

In FIG. 3, #K denotes the row number K.

The K-th row is associated with a predetermined kind of user movement state.

In the example of FIG. 3, in the item of the K-th row, 1st column, “User movement state”, the user movement state corresponding to the K-th row is registered (stored).

In the item of the K-th row, 2nd column, “Detection conditions”, detection conditions for detecting the user movement state corresponding to the K-th row, i.e., the user movement state registered (stored) in the K-th row of 1st column is registered (stored).

More particularly, “Stationary” is stored in the 1st row, 1st column.

A condition “No acceleration detected by triaxial acceleration sensor 20B (Amplitude of component in each direction is below 0.5 G)” is stored in the 1st row, 2nd column.

Accordingly, when the above condition is satisfied, the user movement state is recognized as being “Stationary”.

Similarly, “Walking” is stored in the 2nd row, 1st column.

A condition “Triaxial acceleration sensor 20B detected vertical direction component vibration of acceleration having frequency less than or equal to 2 Hz and amplitude greater than or equal to a predetermined value 1.0 G” is stored in the 1st row, 2nd column.

Accordingly, when the above condition is satisfied, the user movement state is recognized as being “Walking”.

Similarly, “Running” is stored in the 3rd row, 1st column, and a condition “Triaxial acceleration sensor 20B detected vertical direction component vibration of acceleration having frequency exceeding 2 Hz and amplitude greater than or equal to a predetermined value 1.0 G” is stored in the 3rd row, 2nd column.

Accordingly, when the above condition is satisfied, the user movement state is recognized as being “Running”.

Similarly, “Moving on a vehicle” is stored in the 4th row, 1st column, and a condition “Triaxial acceleration sensor detected vertical direction component vibration of acceleration having amplitude below a predetermined value 0.5 G and advancing direction component vibration of acceleration having amplitude greater than or equal to a predetermined value 0.5 G” is stored in the 4th row, 2nd column.

Accordingly, when the above condition is satisfied, the user movement state is recognized as being “Moving on a vehicle”.

The user state detection unit 31 thus executes the state detection processing using the table shown in FIG. 3 and supplies to the display setting unit 32 the processing result, i.e., the detected movement state of the user.

In addition to the user movement state, location information indicative of the current location of the digital camera 1 is supplied to the display setting unit 32.

The display setting unit 32 sets the display form of the map to be displayed on the display unit 16 based on the user movement state and location information thus supplied.

For example, the display setting unit 32 sets display forms such as a scale of a map (hereinafter referred to as “map scale”), the size of a character displayed in the map, and the lighting condition of the backlight 17. The size of a character is hereinafter referred to as “font size”, and the size of a character displayed in the map is hereinafter referred to as “map font size”.

More particularly, in the present embodiment, it is assumed that data of maps in at least “Detailed” and “Normal” scales is stored in the map DB 41, though a detailed description will be given later of the map data.

This means that there are at least 2 levels of map scale, “Detailed” and “Normal”.

It is also assumed that, from among the kinds of user movement state, “Walking” and “Running” are associated with “Detailed” map scale, and “Stationary” and “Moving on a vehicle” are associated with “Normal” map scale.

Consequently, the display setting unit 32 sets the map scale to “Detailed” when the user movement state is “Walking” or “Running”.

On the other hand, the display setting unit 32 sets the map scale to “Normal” when the user movement state is “Stationary” or “Moving on a vehicle”.

Furthermore, for example, in the present embodiment, it is assumed that data of fonts in at least “Large” and “Normal” sizes is stored in the font DB 42; a detailed description will be given later of the map font.

This means that there are at least 2 sizes of map font, “Large” and “Normal”.

It is also assumed that from among the kinds of user movement state, “Running” is associated with “Large” font size, and “Walking”, “Stationary”, and “Moving on a vehicle” are associated with “Normal” font size.

Consequently, the display setting unit 32 sets the map font size to “Large” when the user movement state is “Running”.

On the other hand, the display setting unit 32 sets the map font size to “Normal” when the user movement state is “Walking”, “Stationary”, or “Moving on a vehicle”.

Furthermore, for example, the display setting unit 32 sets the lighting condition of the backlight 17 in accordance with the user movement state and, as a result, can set a display form of the map.

Since the display form (such as brightness) of the display unit 16 changes as the lighting condition of the backlight 17 changes, the setting of the lighting condition of the backlight 17 is indeed the setting of the display form (such as brightness) of the map.

Here, the setting of the lighting conditions of the backlight 17 to be set is not particularly limited and may include setting of changing the brightness (luminance), the setting of changing interval or timing of blinking, or the setting of changing emission color of the backlight 17.

As the method of changing the emission color of the backlight 17, for example, a method can be employed that prepares a plurality of fluorescent lamps or the like that respectively emit colors different from one another, and changes the ratio of brightness (luminance) for each of the plurality of fluorescent lamps or the like.

Furthermore, there is no limitation to the association between the lighting condition of the backlight 17 and the user movement state.

For example, as described above, the user movement states can be classified to some extent by using the vibration frequency and amplitude thereof of the acceleration.

Therefore, it is possible to associate the user movement state with the lighting condition of the backlight 17 by associating the vibration frequency and amplitude thereof of the acceleration with the lighting condition of the backlight 17.

The display setting unit 32, after setting the display form of the map in this way, acquires map information (map data and the like) corresponding to the setting contents from the map DB 41 and a map font of a size corresponding to the setting contents from the font DB 42.

The acquired map information and map font are supplied to the displayed control unit 33.

The display setting unit 32 also supplies to the display control unit 33 the setting contents of the lighting condition of the backlight 17.

The display control unit 33 causes the display unit 16 to display the map based on the map information and map font supplied from the display setting unit 32 in the display form set by the display setting unit 32.

The display control unit 33 also controls the lighting of the backlight 17 based on the setting contents supplied from the display setting unit 32, i.e., in the lighting condition set by the display setting unit 32.

In the present embodiment, the map DB 41 contains data of a map indicative of the state of a land surface expressed on a plane surface scaled at a predetermined ratio, and information, as map information, including at least location information indicative of the latitude, longitude, and altitude of the map.

Incidentally, as the map data format, a vector map format and a raster map format are generally employed. In the present embodiment, however, a description will be given of the case in which the vector map format is employed.

The vector map is intended to mean map data in which data for displaying objects such as roads, facilities, and characters in a map, and data for displaying other elements of the map are separated from each other in advance.

Also, data for displaying each object in the vector map is constituted by data of a set of directed line segments or vectors, to which property information corresponding to the object regarding road width, magnitude, and the like is attached.

Furthermore, in the present embodiment, data of fonts constituting the character objects from among the constituent elements (data) of the vector map is stored in the font DB 42.

The data of fonts is stored in the font DB 42 for each of a plurality of sizes including at least “Large” and “Normal” described above.

The display processing by way of the vector map is not described in detail since it is a well-known technique; however, for example, the display setting unit 32 sets a map range based on the map scale corresponding to the user movement state.

The display setting unit 32 selects objects to be displayed in accordance with the map range based on the property information such as road width and magnitude attached to the data of each object such as a road and a facility, and acquires from the map DB 41 map information including data of the selected objects to be displayed.

Furthermore, the display setting unit 32 acquires from the font DB 42 data of fonts of the size corresponding to the user movement state in order to generate character objects.

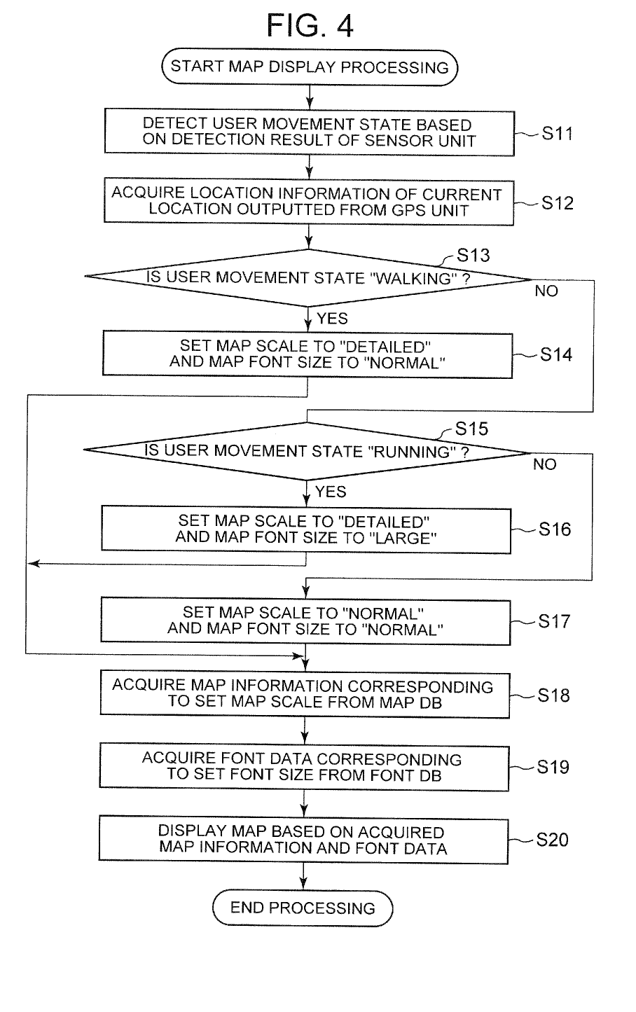

In the following, a description will be given of processing (referred to as “map display processing”) implemented by the functional configuration of FIG. 2 from among the kinds of processing of the digital camera 1 with reference to FIG. 4.

FIG. 4 is a flowchart showing flow of the map display processing.

For ease of description, in the description of the map display processing shown in FIG. 4, the setting of lighting condition of the backlight 17 is omitted, and only setting of map scale and font size is described as the setting of map display form.

For example, in the present embodiment, the map display processing starts at a timing when the operation mode of the digital camera 1 is switched to a GPS mode and, after that, is repeatedly executed at a predetermined time interval.

Here, the GPS mode is one of the operation modes of the digital camera 1 and is intended to mean a mode of displaying on the display unit 16 a map indicative of the current location of the digital camera 1, and the like.

As described above, the operation unit 15 includes a mode switching key to instruct the switching of the operation mode of the digital camera 1.

This means that a user can instruct to switch to the GPS mode by pressing and operating the mode switching key.

When such an instruction is entered to switch to the GPS mode, the map display processing starts, and the following processes of steps S11 to S20 are executed.

In step S11, the user state detection unit 31 detects the user movement state based on the detection result of the sensor unit 20.

More particularly, in the present embodiment, the detection result of the sensor unit 20 is the acceleration data in each direction component outputted from the triaxial acceleration sensor 20B, as described above.

The user state detection unit 31 acquires vibration frequencies and amplitudes thereof from the triaxial acceleration data in each direction component and detects the user movement state especially based on the vibration frequencies and amplitudes thereof.

The user state detection unit 31 supplies thus detected user movement state to the display setting unit 32.

In step S12, the display setting unit 32 acquires the location information of the current location outputted from the GPS unit 18.

In step S13, the display setting unit 32 determines whether or not the user movement state detected by the user state detection unit 31 in the process of step S11 is “Walking”.

In a case in which the user movement state is “Walking”, a determination of YES is made in step S13, and control proceeds to step S14.

In step S14, the display setting unit 32 sets the map scale to “Detailed” and the map font size to “Normal”.

As described above, when the user movement state is “Walking”, the map scale is set to “Detailed”, which is appropriate for the user walking speed.

The map scale is set to “Detailed”, since the user moves slowly when walking and needs detailed information of the vicinity.

With this, it becomes possible to display a map that is highly useful while walking.

Although it has been described that the map scale and the map font size are set in step S14, in a case in which the user has already set the map scale to “Detailed” before step S14, only the map font size is set to “Normal”.

On the other hand, if the user movement state is not “Walking” but “Stationary”, “Running”, or “Moving on a vehicle”, a determination of NO is made in step S13, and control proceeds to step S15.

In step S15, the display setting unit 32 determines whether or not the user movement state detected by the user state detection unit 31 in the process of step S11 is “Running”.

In a case in which the user movement state is “Running”, a determination of YES is made in step S15, and control proceeds to step S16.

In step S16, the display setting unit 32 sets the map scale to “Detailed” and the map font size to “Large”.

As described above, when the user movement state is “Running”, the map scale is set to “Detailed”, which is appropriate for the user running speed.

This means that the map scale is set to “Detailed”, since the user moves relatively slow while running and needs detailed information of the vicinity.

With this, it becomes possible to display a map that is highly useful while running.

Furthermore, since it becomes difficult to view and recognize the characters on the map due to bouncing while running, the font size of characters displayed on the map is changed to “Large”, and thereby it becomes possible to display a map that is highly legible while running.

On the other hand, if the user movement state is not “Running” but “Stationary” or “Moving on a vehicle”, a determination of NO is made in step S15, and control proceeds to step S17.

In step S17, the display setting unit 32 sets the map scale to “Normal” and the map font size to “Normal”.

In this process, by setting the map scale to “Normal” when the user movement state is other than “Walking” or “Running”, it becomes possible to restore the map scale that is most appropriate for the state of being stationary or moving at a speed of a vehicle, such as a car or a tram.

Furthermore, by restoring the map font size to “Normal” when the user movement state is other than “Walking” or “Running”, it becomes possible to enhance the legibility of characters displayed on the map.

This means that, while remaining stationary or in a vehicle such as a car or a tram, the default state of the map is restored, and thereby it becomes possible to display a map convenient for grasping an overview of the entire map.

Furthermore, since it is insusceptible to vibration while stationary or in a vehicle such as a car or a tram, the map font size is changed to “Normal”, and it becomes possible to easily view a wide range map, thereby enhancing usability for a user.

After the map scale and map font size are set in the process of step S14, step S16, or step S17, control proceeds to step S18.

In step S18, the display setting unit 32 acquires from the map DB 41 the map information corresponding to the map scale set in the process of step S14, step S16, or step S17.

More particularly, the display setting unit 32 recognizes a plurality of maps including the current location based on the location information acquired in the process of step S12 and acquires from the map DB 41 the map information including data of the map in the scale set from among the maps.

In step S19, the display setting unit 32 acquires from the font DB 42 data of a font of the corresponding size based on the map font size set in the process of step S14, step S16, or step S17.

In step S20, the display control unit 33 causes the display unit 16 to display the map based on the map information acquired in the process of step S18 and the font data acquired in the process of step S19.

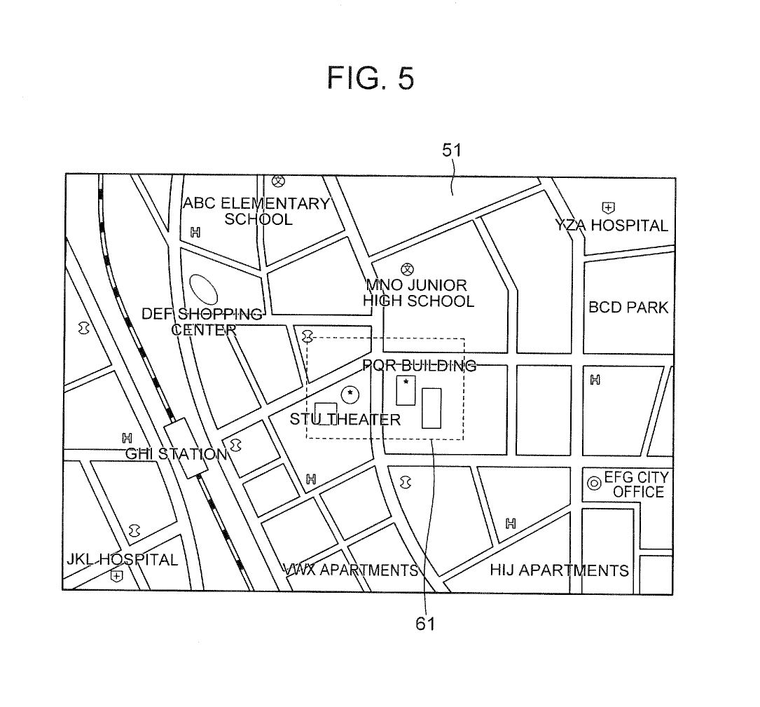

With this, in the present embodiment, a map is displayed on the display unit 16 in a display form appropriate for the user movement state as shown in FIGS. 5 to 7.

FIGS. 5 to 7 are examples of the map displayed on the display unit 16.

FIG. 5 shows, as one example of the map displayed on the display unit 16, a map 51 in a case in which the map scale is set to “Normal” and the map font size is set to “Normal”.

This means that map 51 shown in FIG. 5 is displayed on the display unit 16 when the user movement state is other than “Walking” or “Running”, i.e., “Stationary” or “Moving on a vehicle”.

In the map 51, the area 61 shows a geographical range that will be displayed when the map scale is set to “Detailed”. It is to be understood that the geographical range displayed in the map 51 in the scale of “Normal” is wider than the geographical range displayed when the map scale is set to “Detailed”.

Furthermore, in the example of the map 51 shown in FIG. 5, a plurality of names of facilities are displayed in characters.

The font size of those characters is set to “Normal”, i.e., 14 points, for example.

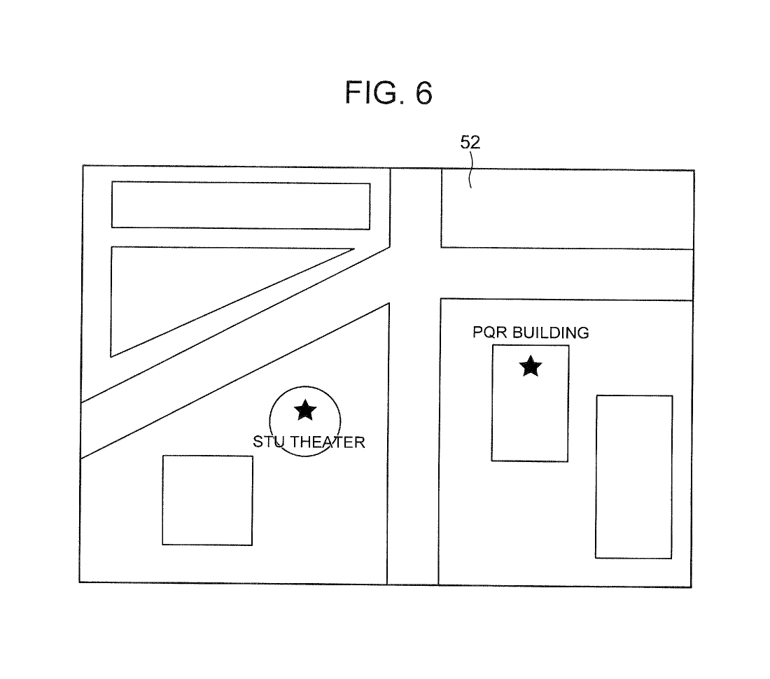

FIG. 6 shows, as another example of the map displayed on the display unit 16, a map 52 in a case in which the map scale is set to “Detailed” and the map font size is set to “Normal”.

This means that the map 52 shown in FIG. 6 is displayed on the display unit 16 when the user movement state is “Walking”.

The map 52 shows a geographical range corresponding to the area 61 of the map 51 that is displayed when the map scale is set to “Normal”.

It is to be understood that the geographical range of the map 52 in the scale of “Detailed” is smaller than the geographical range displayed when the map scale is set to “Normal”.

Furthermore, in the example of the map 52 shown in FIG. 6, a plurality of names of facilities are displayed in characters.

The font size of those characters is set to “Normal”, i.e., 14 points, for example.

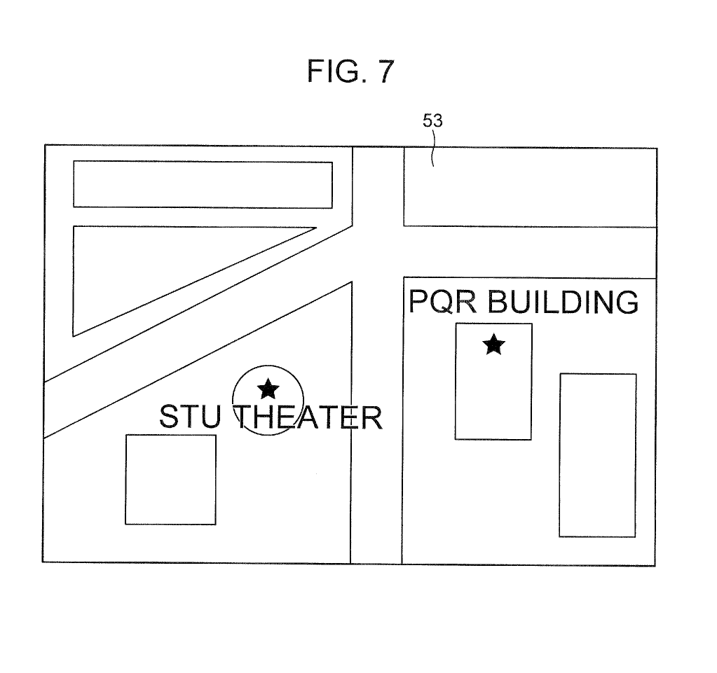

FIG. 7 shows, as another example of the map displayed on the display unit 16, a map 53 in a case in which the map scale is set to “Detailed” and the map font size is set to “Large”.

This means that the map 53 shown in FIG. 7 is displayed on the display unit 16 when the user movement state is “Running”.

The map 53 shows a geographical range corresponding to the area 61 of the map 51 that is displayed when the map scale is set to “Normal”.

It is to be understood that the geographical range of the map 53 in the scale of “Detailed” is smaller than the geographical range displayed when the map scale is set to “Normal”.

Furthermore, in the example of the map 53 shown in FIG. 7, a plurality of names of facilities are displayed in characters.

The font size of those characters is set to “Large”, i.e., 28 points, for example.

After the maps shown in FIGS. 5 to 7 are displayed in the process of step S20 of FIG. 4, the map display processing ends.

After that, the map display processing is repeatedly executed at a predetermined time interval.

Therefore, the display form of the map changes momentarily in accordance with the user movement state that changes from moment to moment in time.

For example, in a case in which the user movement state transits from “Stationary” to “Walking” and then to “Running”, the above-mentioned maps of FIGS. 5 to 7 are sequentially displayed on the display unit 16 in accordance with the transition of the user movement state.

As described above, the digital camera 1 of the present embodiment is provided with a user state detection unit 31, a display setting unit 32, and a display control unit 33.

The user state detection unit 31 detects a kind indicative of the user current movement state from among a plurality of kinds of user movement state.

The display setting unit 32 sets a display form of a map based on the kind of user movement state detected by the user state detection unit 31.

The display control unit 33 controls the display of the map in the display form set by the display setting unit 32.

With this, it becomes possible to automatically display a map appropriate for the user movement state.

Furthermore, the user state detection unit 31 acquires a vertical vibration frequency from at least the X axis direction component of the triaxial acceleration data from the triaxial acceleration data of the triaxial acceleration sensor 20B and detects the user movement state based on the vertical vibration frequency.

Here, the user state detection unit 31 can detect at least two kinds of the user movement state, i.e., “Walking” and “Running” in a clearly-distinguishable manner.

Therefore, it becomes possible to selectively display a map in respective display forms appropriate for the state of “Walking” and the other state of “Running”.

Furthermore, based on the detection result of the user state detection unit 31, the display setting unit 32 sets the scale of the map whose display is controlled by the display control unit 33.

For example, in a case in which the user movement state is of a kind of slow moving, more particularly, “Walking”, “Running”, or the like, the user may well need detailed information of the vicinity.

In such a case, the display setting unit 32 may set the map scale to “Detailed”.

As a result of this, the usability for a user to read the map is enhanced.

Furthermore, based on the detection result of the user state detection unit 31, the display setting unit 32 sets the font size of the map to be displayed under the control of the display control unit 33.

For example, in a case in which the user movement state is of a shaking kind, more particularly, “Running” or the like, the user may well have difficulty in viewing and recognizing the characters on the map.

In such a case, the display setting unit 32 may set the map font size to “Large”.

As a result of this, the legibility of the map is enhanced and the usability for a user to read the map is further enhanced.

The digital camera 1 of the present embodiment is further provided with a GPS unit 18 capable of acquiring the location information indicative of the current location thereof.

The display setting unit 32 sets the display form of the map including the current location specified by the location information acquired by the GPS unit 18.

As a result, since the map corresponding to the current location is displayed, the usability for a user is further enhanced.

Furthermore, the display control unit 33 executes control of displaying the map on the display unit 16 illuminated by a backlight 17.

The display setting unit 32 sets the lighting condition of the backlight 17 based on the detection result of the user state detection unit 31.

Thus, it becomes possible to display a map appropriate in accordance with the user movement state.

It should be noted that the present invention is not limited to the embodiment described above, and any modifications and improvements thereto within a scope in which an object of the present invention can be realized, are included in the present invention.

For example, in the embodiment described above, it has been described that the map scale is set to “Detailed” in a case of “Walking” and “Running”, and the map font size is set to “Large” in a case of “Running”. However, the font size may be set in such a manner that the font size gradually enlarges as the user moving speed increases from “Stationary” to “Walking” and then to “Running” while the map scale remains unchanged.

For example, in the embodiment described above, it has been described that the autonomous navigation control unit 21A calculates the moving distance of the digital camera 1 by integrating the triaxial acceleration data sequentially outputted from the triaxial acceleration sensor 20B. However, the autonomous navigation control unit 21A may calculate the moving distance by counting the number of steps based on upward and downward changes in acceleration detected from the output of the triaxial acceleration sensor 20B, and multiplying the number of steps by a predetermined step length.

For example, in the embodiment described above, it has been described that the user state detection unit 31 detects the user movement state based on the vibration frequency and the amplitude thereof from the output value (the triaxial acceleration data) of the triaxial acceleration sensor 20B. However, the method of detecting the user movement state is not limited thereto.

Furthermore, a description has been given in the embodiment in which the information display apparatus according to the present invention is configured by the digital camera 1.

However, the present invention is not limited to this and can be applied to any electronic device that is provided with a function of displaying a map. For example, the present invention can be widely applied, to a portable personal computer, a portable navigation device, a portable game device, and the like.

The series of processes described above can be executed by hardware and also can be executed by software.

In a case in which the series of processes are to be executed by software, a program configuring the software is installed from a network or a storage medium into a computer or the like.

The computer may be a computer embedded in dedicated hardware.

Alternatively, the computer may be capable of executing various functions by installing various programs, i.e., a general-purpose personal computer, for example.

The storage medium containing the program can be constituted not only by the removable media 23 distributed separately from the device main body for supplying the program to a user, but also can be constituted by a storage medium or the like supplied to the user in a state incorporated in the device main body in advance.

The removable media 23 is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), and the like.

The magnetic optical disk is composed of an MD (Mini-Disk) or the like.

The storage medium supplied to the user in the state incorporated in the device main body in advance includes the memory 12 storing the program, a hard disk, and the like, for example.

It should be noted that in the present specification the steps describing the program stored in the storage medium include not only the processing executed in a time series following this order, but also processing executed in parallel or individually, which is not necessarily executed in a time series.

What is claimed is:

1. An information display apparatus, comprising:
a storage unit that stores map data;
a display unit;
a user state detection unit that detects a user movement state indicative of a current user movement state;
a display setting unit that sets a display form of the map data to be displayed by the display unit based on the user movement state detected by the user state detection unit; and
a display control unit that controls a display of the map data by the display unit in the display form set by the display setting unit.

2. An information display apparatus as set forth in claim 1, further comprising an acceleration sensor, wherein
the user state detection unit calculates a vibration frequency on the basis of an output from the acceleration sensor, and detects a kind of user movement state indicative of a current user movement state based on the vibration frequency in a vertical direction.

3. An information display apparatus as set forth in claim 1, further comprising an acceleration sensor, wherein
the user state detection unit detects a kind of user movement state indicative of a current user movement state based on an amplitude on the basis of an output from the acceleration sensor.

4. An information display apparatus as set forth in claim 1, wherein
the display setting unit sets a scale of a map to be displayed under control of the display control unit, based on a detection result detected by the user state detection unit.

5. An information display apparatus as set forth in claim 1, wherein
the display setting unit sets character size in a map to be displayed under control of the display control unit, based on a detection result of the user state detection unit.

6. An information display apparatus as set forth in claim 1, wherein
the display control unit executes control of displaying the map on a display unit illuminated by a backlight, and
the display setting unit sets a lighting condition of the backlight based on a detection result of the user state detection unit.

7. An information display apparatus as set forth in claim 1, further comprising a location information acquiring unit that acquires location information indicative of a current location of the information display apparatus, wherein
the display setting unit sets a display form of a map including a current location specified by the location information acquired by the location information acquiring unit.

8. An information display method of an information display apparatus that displays map data stored in a storage unit on a display unit, the method comprising:
a user state detection step of detecting a user movement state indicative of a current user movement state;
a display setting step of setting a display form of the map data to be displayed by the display unit based on the user movement state detected in the user state detection step; and
a display control step of controlling a display of the map data by the display unit in the display form set in the display setting step.

9. A storage medium having stored therein a program causing a computer that controls an information display apparatus that displays map data stored in a storage unit on a display unit to implement:
a user state detection function that detects a kind of user movement state indicative of a current user movement state;
a display setting function that sets a display form of the map data to be displayed by the display unit based on the user movement state detected by the user state detection function; and
a display control function that controls a display of the map data by the display unit in the display form set by the display setting function.
